(19) United States
(12) Patent Application Publication
(10) Pub. No.: US 2007/0195768 A1
(43) Pub. Date: Aug. 23, 2007

(54) Packet routing method and packet routing device

(76) Inventors: Takeshi Kanazawa, Kanagawa (JP); Naoto Oka, Kanagawa (JP); Toyoki Kawahara, Tokyo (JP); Hirokazu Kobayashi, Kanagawa (JP)

Correspondence Address: STEVENS, DAVIS, MILLER & MOSHER, LLP, 1615 L. STREET N.W., SUITE 850, WASHINGTON, DC, 20036, US

(21) Appl. No.: 10/589,637

(22) PCT Filed: Feb. 18, 2005
(86) PCT No.: PCT/JP05/02597

§ 371 Date: Oct. 4, 2006

(30) Foreign Application Priority Data
Feb. 19, 2004 (JP) 2004-043562
Feb. 16, 2005 (JP) 2005-039447

(51) Int. Cl. H04L 12/56

(52) U.S. Cl. 370/390

(57) ABSTRACT

A packet routing apparatus that simultaneously implements prompt route recovery and continuation of communication by an optimal route. A radio reception section (103) receives a radio signal including packet data received in a transmission/reception antenna (101) via a circulator (102). Further, the radio reception section (103) detects disconnection of an adhoc network by a decrease in electric filed strength of a signal from a communicating party. A radio reception section (104) transmits a radio signal including a route search packet, route response packet or the like from the transmission/reception antenna (101) via the circulator (102). When the adhoc network is disconnected, a control section (105) performs processing of route recovery for transmitting a route search packet to a destination wireless adhoc terminal, while performing route reconstruction processing for reporting route disconnection to a transmission source wireless adhoc terminal.

### TECHNICAL FIELD

The present invention relates to a packet routing method and packet routing apparatus in a wireless adhoc network where wireless terminals can move freely, and more particularly, to a packet routing method and packet routing apparatus for recovering a route.

### Background Art

As conventional technique for performing wireless packet communication on an adhoc network where a plurality of freely moving wireless terminals communicate with one another, there exists the AODV (Adhoc On-demand Distance Vector) routing protocol being standardized by MANET (Mobile Adhoc NETworks) working group of IETF (Internet Engineering Task Force).

On MANET, even when a transmission source terminal that is an originator of data packets cannot directly communicate with a destination terminal that is a destination of the transmitted data packets due to the distance and the like, one or a plurality of wireless terminals existing between the transmission source terminal and destination terminal are made to relay the data packets. It is thereby possible to transfer data from the transmission source terminal to the destination terminal when the originating terminal cannot communicate directly with the destination terminal.

In constructing a communication route from the transmission source terminal to destination terminal, there are two main methods in MANET. One of the methods is performed by on-demand type routing protocol such as AODV to construct the communication route only when a communication request is made from application and the like. The other one is performed by table driving type routing protocol such as OLSR (Optimized Link State Routing) that transmits packets at regular intervals for route construction (update) to all the terminals as in the routing protocol in wired networks.

In the on-demand type routing protocol, since route search is performed whenever data is transmitted, the transmission cost is high for each transmission, but a communication band is not regularly consumed, and therefore, effects on the other terminals and power consumption can be reduced. Meanwhile, in the table driving type routing protocol, since the route is constructed in advance, the protocol is advantageous when each terminal has a high frequency of transmitting data. However, since the communication band is regularly consumed to construct (update) the route, when a wireless medium is shared, the possibility increases of affecting other terminals transmitting data.

In view of the foregoing, when an adhoc network is constructed using terminals driven by batteries, the on-demand type routing protocol is generally used.

However, in the wireless adhoc network using the on-demand type routing protocol, when a wireless terminal on a specific communication route moves or turns off the power during relay of data packets, it is not possible to relay the data packets. Therefore, in such a case, it is necessary to establish a new communication route.

In general, as a method of establishing a communication route, such a method is used in which a packet for construction of a communication route is transmitted by broadcast, each wireless terminal receives the result, and the communication route is thereby constructed. In the above-mentioned AODV protocol, reconstruction of a communication route is carried out as shown in FIGS. 1 to 6.

Herein, as shown in FIG. 1, it is assumed that data packets are transmitted on a transmission route of transmission source terminal 20→relay terminal 13→relay terminal 16→relay terminal 18→destination terminal 21. When it becomes impossible to relay data packets due to moving of destination terminal 21 and the like, relay terminal 18 recognizing the impossibility determines that update of the route is required.

In other words, relay terminal 18 monitors a reception level of the radio wave, for example, and, when the level falls below a given fixed level, detects deterioration of a communication state with destination terminal 21 i.e. disconnection of the route. Relay terminal 18 searches for an immediately preceding terminal (herein, relay terminal 16) which uses the terminal 18 as the route to destination terminal 21, and transmits to the preceding terminal a route error packet for reporting that the route is unavailable.

The terminal receiving the route error packet searches for an immediately preceding terminal that specifies the terminal on the route, and, when such a terminal exists, transmits the route error packet to the preceding terminal. By repeating such processing, the route error packet is transferred to transmission source terminal 20. As shown in FIG. 2, transmission source terminal 20 floods again a route search packet to destination terminal 21. Then, as shown in FIG. 3, destination terminal 21 transmits a route response packet to transmission source terminal 20, and the route is thus reconstructed.

Further, when relay terminal 18 detecting disconnection of the route is located near destination terminal 21 to some extent, relay terminal 18 can recover the route. In this case, as shown in FIG. 4, relay terminal 18 floods a route search packet for searching for a route to destination terminal 21.

However, a range to which the route search packet spreads is calculated and adjusted so that the packet does not reach transmission source terminal 20 of the packet. Each relay terminal receiving the route search packet repeats flooding as long as the transfer is permitted, and the packet is finally transferred to destination terminal 21. As shown in FIG. 5, destination terminal 21 receiving the route search packet transmits a route response packet to relay terminal 19 that has transmitted the route search packet, relay terminal 19 transfers the received route response packet to relay terminal 18, and a route from relay terminal 18 to destination terminal 21 is thus constructed.

In this way, the original route of transmission source terminal 20→relay terminal 13→relay terminal 16→relay terminal 18→destination terminal 21 is recovered as a route of transmission source terminal 20→relay terminal 13→relay terminal 16→relay terminal 18→relay terminal 19→destination terminal 21, and the communication between the transmission source and destination is continued.

Further, in this case, the number of relays after route recovery is larger than that before route recovery, and therefore, as shown in FIG. 6, as in transmission of a route error packet, when route disconnection is detected, relay terminal 18 floods to transmission source terminal 20 the route error packet including information indicating that the number of relays after route recovery is larger than that before route recovery.

Transmission source terminal 20 receiving the route error packet may use the recovered route continuously, or may reconstruct a new route by exchanging the route search packet and route response packet as shown in FIGS. 2 and 3.

Non-patent Document 1: RFC3561

### DISCLOSURE OF INVENTION

Problems to be Solved by the Invention

However, in recovering the route in a relay terminal by the above-mentioned AODV protocol, the relay terminal waits for arrival of a route response packet from a destination terminal for predetermined time after transmitting a route search packet to the destination terminal. When the route response packet does not arrive within the time, the relay terminal determines that route recovery is impossible, and transmits a route error packet to a transmission source terminal, and therefore, a route error report to the transmission source terminal is delayed, and the time increases that elapsed before the transmission source terminal performs reconstruction of the route to the destination terminal.

Further, when the relay terminal receives the route response packet from the destination terminal within the predetermined time, it is considered that as a route from the transmission source terminal to the destination terminal, an optimal route is another route not passing through the relay terminal that detects disconnection of the communication (the number of relays is smaller in the communication route in FIG. 3 than in the communication route in FIG. 6.) Further, when the route error packet is transmitted to the transmission source terminal via the recovered route, since the number of relays is larger in the recovered route than in the original route, the route recovery report to the transmission source terminal is delayed, and the time increases that elapsed before the transmission source terminal performs construction of an optimal route to the destination apparatus.

Thus, in the above-mentioned method, the problem arises that it is difficult to simultaneously implement prompt route recovery and continuation of the communication by an optimal route.

It is therefore an object of the present invention to provide a packet routing method and packet routing apparatus that simultaneously implement prompt route recovery and continuation of the communication by an optimal route by a transmission source terminal performing reconstruction of a route to a destination terminal concurrently with recovery of the route to the destination terminal by a relay terminal detecting relay disconnection in reconstructing the route on a network.

Means for Solving the Problem

A packet routing apparatus of the present invention adopts a configuration provided with a receiver that receives a radio signal including packets, a detector that detects disconnection of a route for packet transfer, and a transmitter that, when the route for packet transfer is disconnected, transmits by broadcast a route search request to a destination of the packets and reports the disconnection of the route for packet transfer to a transmission source of the packets.

According to this configuration, a relay terminal that detects disconnection of the route transmits a route search packet to a destination terminal and reports to a transmission source terminal the disconnection of the route, and it is thereby possible to promptly recover the route to the destination terminal by the relay terminal and reduce the time elapsed before the transmission source terminal starts a search for an optimal route. Further, even when the relay terminal fails to recover the route to the destination terminal, it is possible to reduce the time elapsed before the transmission source terminal starts a search for a route to the destination terminal.

Advantageous Effect of the Invention

According to the present invention, a relay terminal that detects disconnection of the route transmits a route search packet to a destination terminal and reports to a transmission source terminal the disconnection of the route, and it is thereby possible to promptly recover the route to the destination terminal by the relay terminal and reduce the time elapsed before the transmission source terminal starts a search for an optimal route. Further, even when the relay terminal fails to recover the route to the destination terminal, it is possible to reduce the time elapsed before the transmission source terminal starts a search for a route to the destination terminal. It is thereby possible to simultaneously implement prompt route recovery and continuation of the communication by an optimal route.

### BRIEF DESCRIPTION OF THE DRAWINGS

FIG. 1 is a view of a network using conventional wireless adhoc terminals;

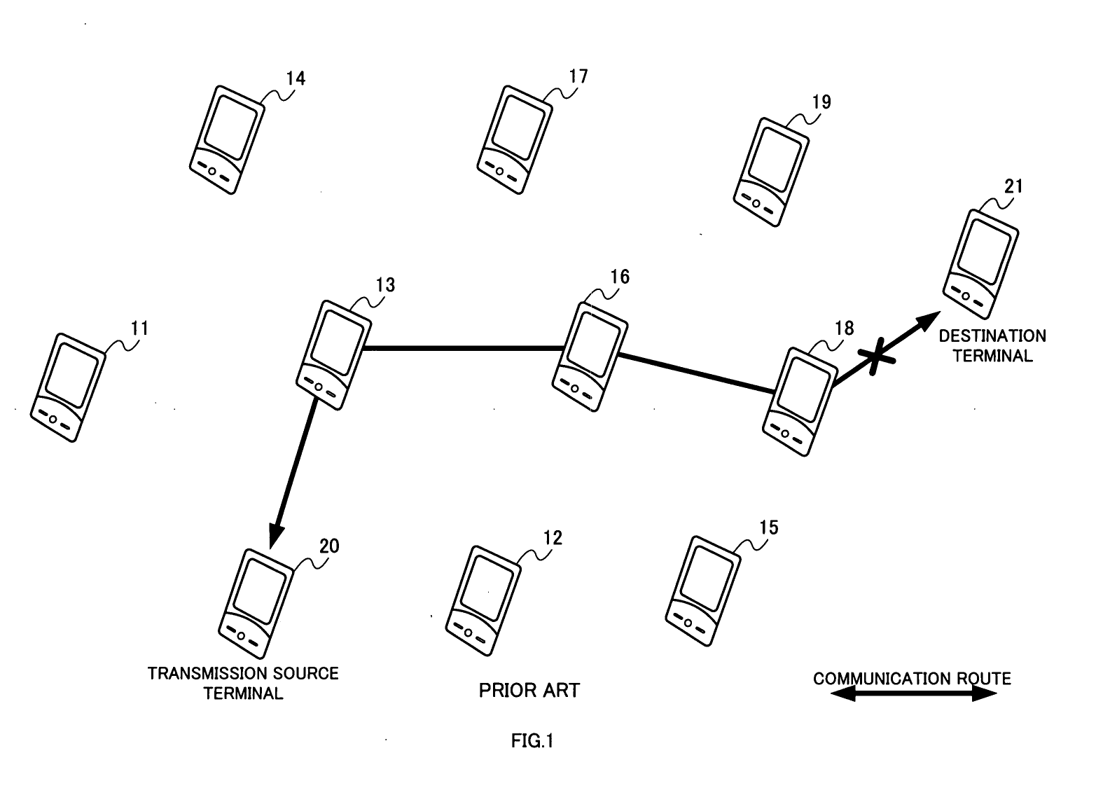

FIG. 2 is another view of the network using conventional wireless adhoc terminals;

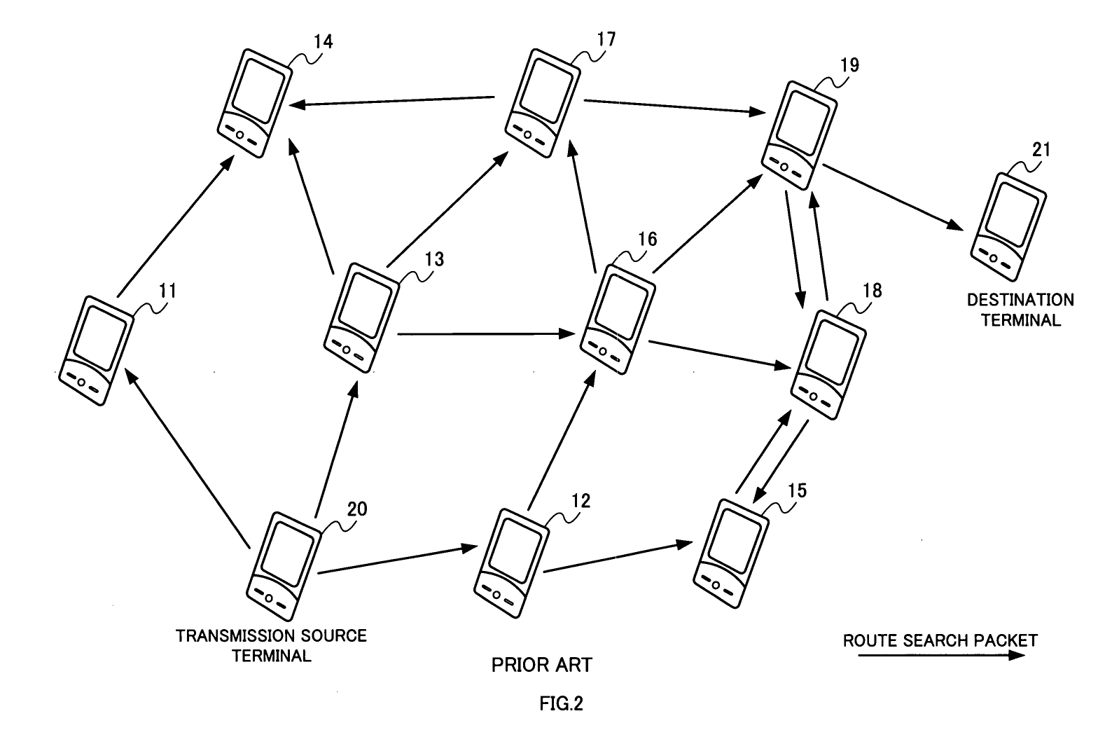

FIG. 3 is another view of the network using conventional wireless adhoc terminals;

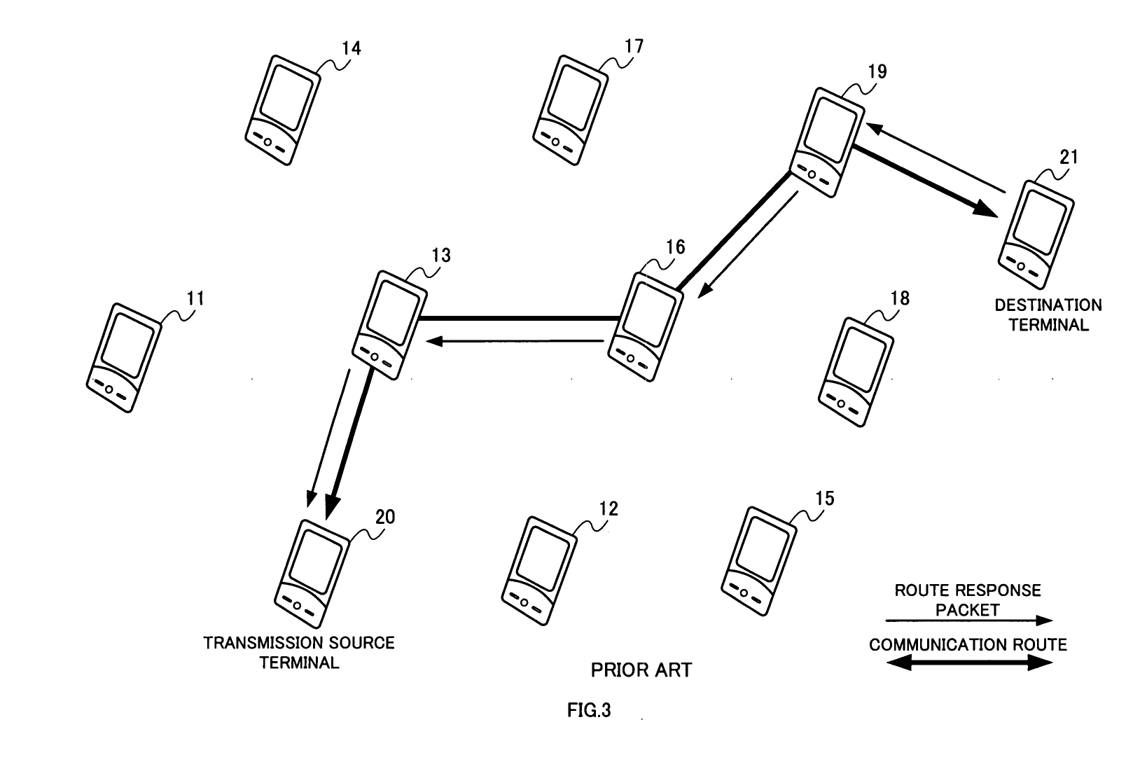

FIG. 4 is another view of the network using conventional wireless adhoc terminals;

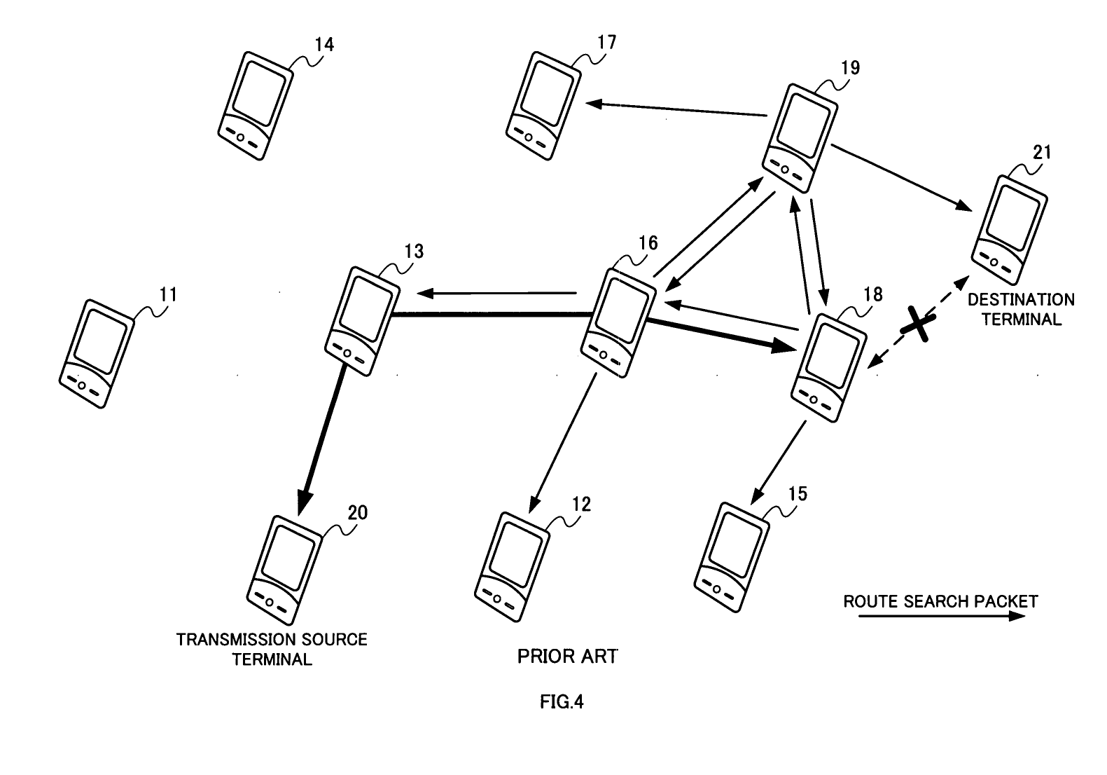

FIG. 5 is another view of the network using conventional wireless adhoc terminals;

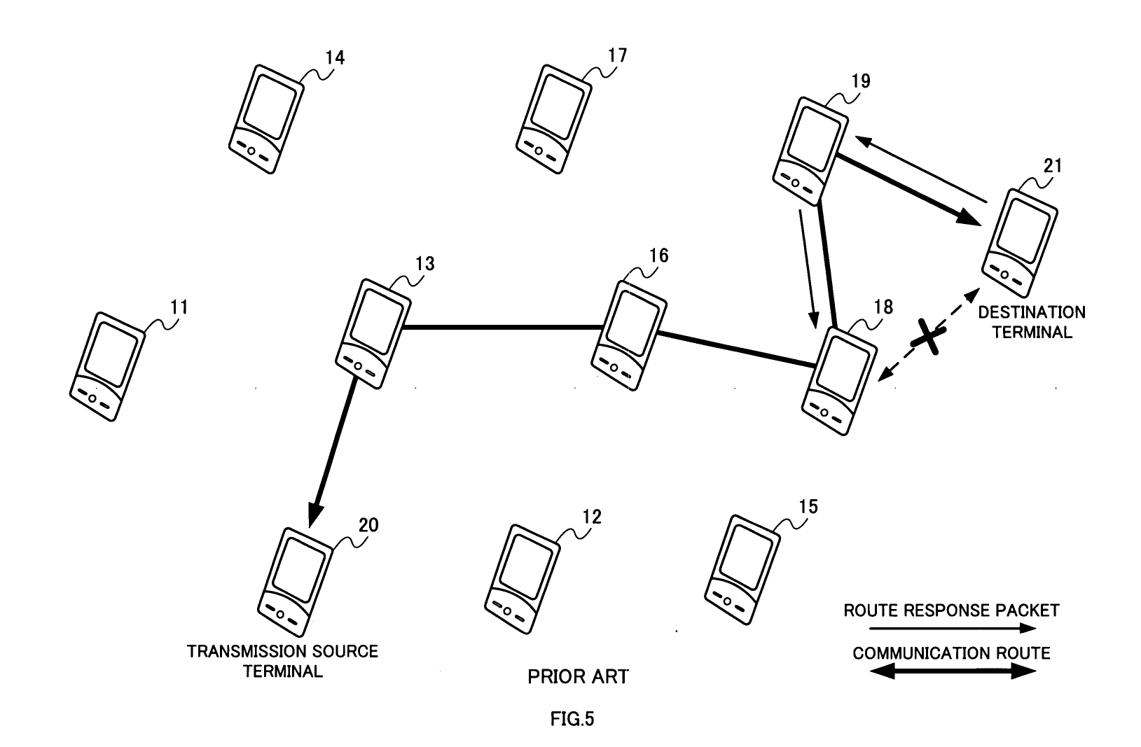

FIG. 6 is still another view of the network using conventional wireless adhoc terminals;

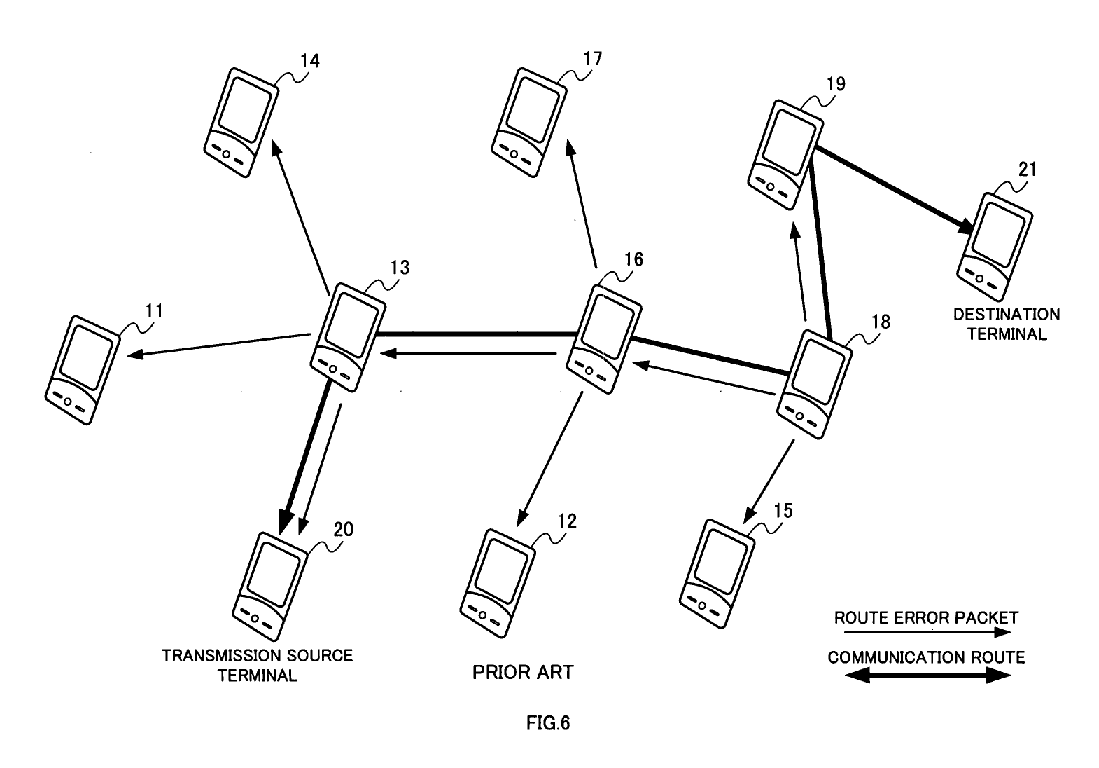

FIG. 7 is a block diagram illustrating a configuration of a wireless adhoc terminal according to one embodiment of the present invention;

FIG. 8 is a flow diagram illustrating control processing of the wireless adhoc terminal as shown in FIG. 7;

FIG. 9 is a view of a network using the wireless adhoc terminal as shown in FIG. 7;

FIG. 10 is another view of the network using the wireless adhoc terminal as shown in FIG. 7;

FIG. 11 is another view of the network using the wireless adhoc terminal as shown in FIG. 7;

FIG. 12 is a flow diagram illustrating processing for receiving a route error packet as shown in FIG. 8;

FIG. 13 is a flow diagram illustrating processing for receiving a route search packet as shown in FIG. 8;

FIG. 14 is a flow diagram illustrating processing for receiving a route response packet as shown in FIG. 8;

FIG. 15 is a flow diagram illustrating processing for receiving a data transmission packet as shown in FIG. 8;

FIG. 16 is a flow diagram illustrating processing for receiving a data relay packet as shown in FIG. 8;

FIG. 17 is another view of the network using the wireless adhoc terminal as shown in FIG. 7;

FIG. 18 is another view of the network using the wireless adhoc terminal as shown in FIG. 7;

FIG. 19 is another view of the network using the wireless adhoc terminal as shown in FIG. 7;

FIG. 20 is a diagram illustrating a format of the route search packet;

FIG. 21 is another view of the network using the wireless adhoc terminal as shown in FIG. 7; and

FIG. 22 is still another view of the network using the wireless adhoc terminal as shown in FIG. 7.

### BEST MODE FOR CARRYING OUT THE INVENTION

An embodiment of the present invention will be described below in detail with reference to accompanying drawings.

### One Embodiment

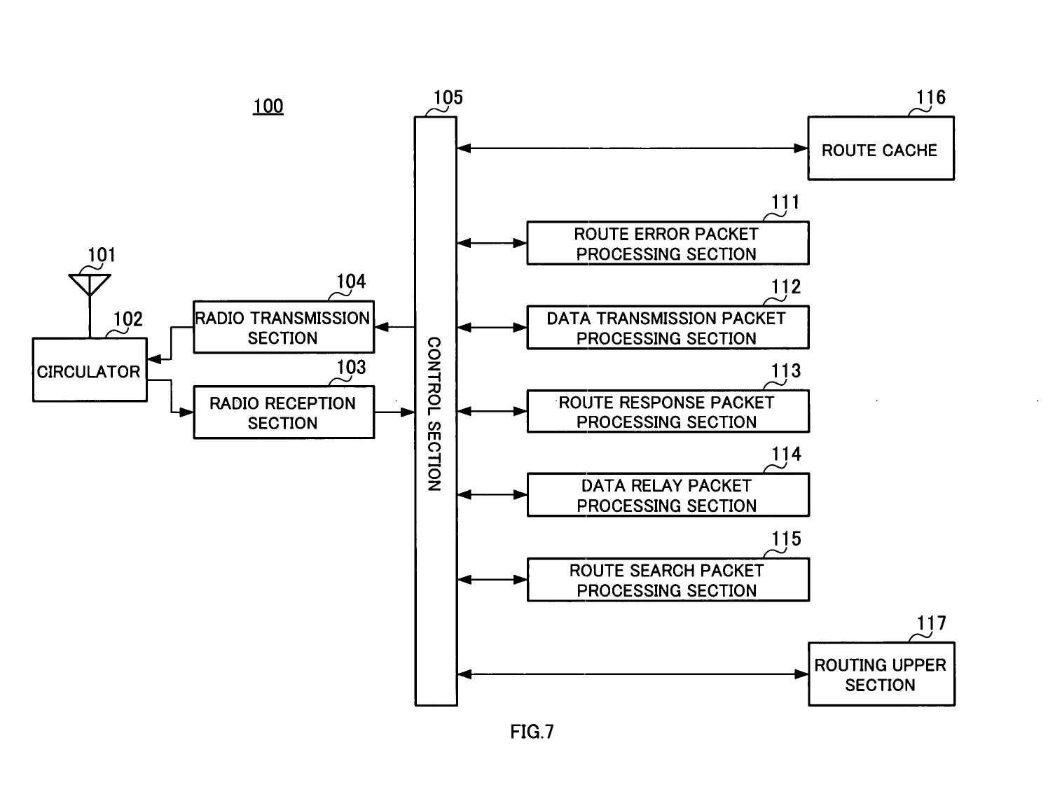

FIG. 7 is a block diagram illustrating a configuration of wireless adhoc terminal 100 according to one embodiment of the present invention. In this figure, a radio signal including packet data received at transmission/reception antenna 101 is inputted to radio reception section 103 via circulator 102. A signal outputted from radio transmission section 104 is transmitted from transmission/reception antenna 101 via circulator 102.

Radio reception section 103 demodulates the radio signal inputted from circulator 102, and outputs the demodulated signal to control section 105. Further, radio reception section 103 monitors the electric field strength and the like of the inputted radio signal, and, when detecting a decrease in electric field strength, radio reception section 103 determines that communication with a terminal to which the packet is directly transmitted is disconnected. Radio reception section 103 reports detection of the disconnection of the communication to control section 105.

Radio transmission section 104 modulates a signal outputted from control section 105, and outputs the modulated signal to circulator 102.

When the adhoc network is disconnected, control section 105 performs processing of route recovery to transmit a route search packet to a destination terminal, while performing processing of route reconstruction to report disconnection of the route to a transmission source terminal.

When the route is disconnected, route error packet processing section 111 performs control to transmit a route error packet. Data transmission packet processing section 112 performs reception processing of a data transmission packet received from routing upper section 117 via control section 105.

Route response packet processing section 113 determines whether or not to relay a route response packet and performs processing of route response. Data relay packet processing section 114 refers to route recovery cache 116, checks whether an already stored terminal exists, determines whether the number of relay terminals to transmit packets is less or not less than a predetermined number, and performs processing of route setting.

Route search packet processing section 115 performs processing of a route search packet. Route recovery cache 116 stores the content of the route search packet for route recovery transmitted from a relay terminal. Routing upper section 117 performs processing of upper protocol.

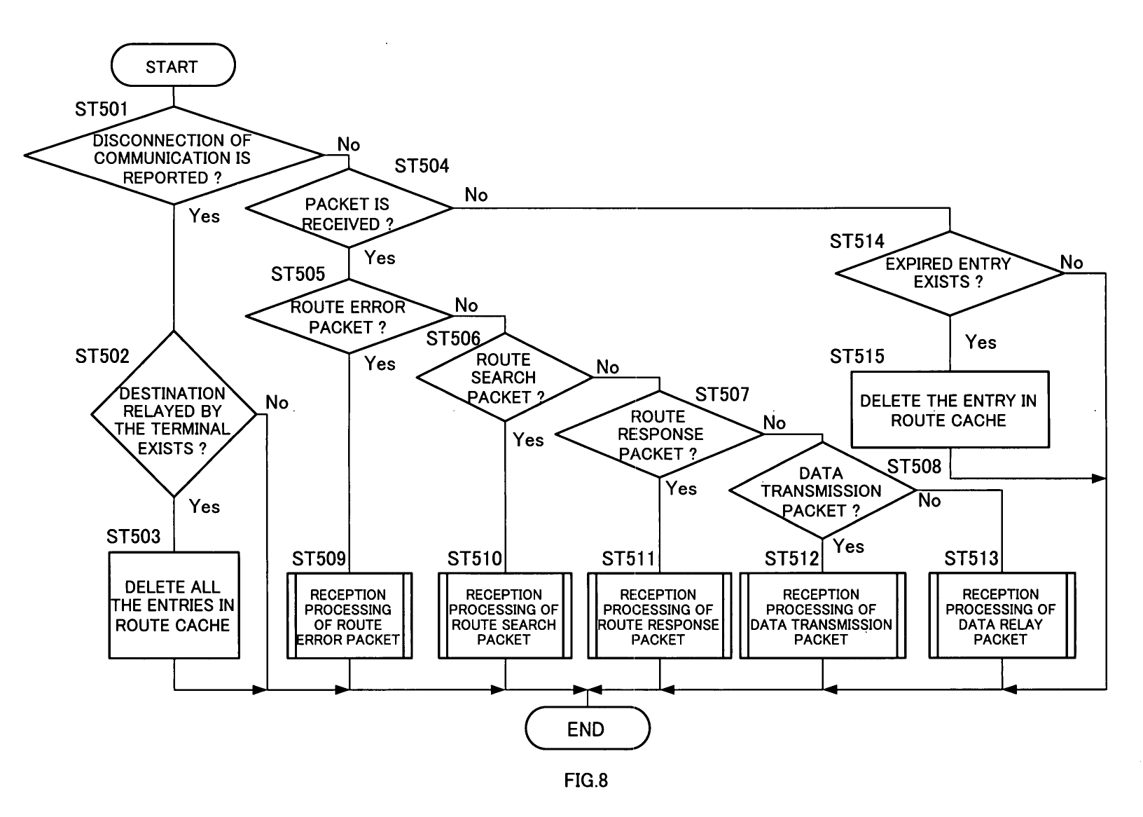

Next, control processing of the wireless adhoc terminal with the above-mentioned configuration will be described below with reference to FIG. 8. In FIG. 8, in step (hereinafter, referred to as “ST”) 501, control section 105 determines whether or not a report of disconnection of the communication is received from radio reception section 103. When control section 105 determines that the report of disconnection of the communication is received (Yes), the processing flow shifts to ST502. When control section 105 determines that the report of disconnection of the communication is not received (No), the processing flow shifts to ST504.

In ST502, control section 105 searches route cache 116 for identification information of the communicating-party terminal with which the communication is disconnected and the destination terminal to directly transmit the packet, and, when the identification information of the destination terminal exists (Yes), the processing flow shifts to ST503, and, when the identification information of the destination terminal does not exist (No), the control processing is finished.

In ST503, control section 105 deletes all the entries corresponding to the destination terminal searched in route cache 116 in ST502, and finishes the control processing.

In ST504, control section 105 determines whether or not a packet is received from radio reception section 103, and, when the packet is received (Yes), the processing flow shifts to ST505, and, when the packet is not received (No), the processing flow shifts to ST514.

In ST505, control section 105 determines whether or not the received packet is a route error packet, and, when the packet is the route error packet (Yes), the processing flow shifts to ST509, and, when the packet is not the route error packet (No), the processing flow shifts to ST506.

In ST506, control section 105 determines whether or not the received packet is a route search packet, and, when the packet is the route search packet (Yes), the processing flow shifts to ST510, and, when the packet is not the route search packet (No), the processing flow shifts to ST507.

In ST507, control section 105 determines whether or not the received packet is a route response packet, and, when the packet is the route response packet (Yes), the processing flow shifts to ST511, and, when the packet is not the route search packet (No), the processing flow shifts to ST508.

In ST508, control section 105 determines whether or not the received packet is a data transmission packet, and, when the packet is the data transmission packet (Yes), the processing flow shifts to ST512, and, when the packet is not the data transmission packet (No), the processing flow shifts to ST513.

In ST509, route error packet processing section 111 performs reception processing of the route error packet, and finishes the control processing.

In ST510, route search packet processing section 115 performs reception processing of the route search packet, and finishes the control processing.

In ST511, route response packet processing section 113 performs reception processing of the route response packet, and finishes the control processing.

In ST512, data transmission packet processing section 112 performs reception processing of the data transmission packet, and finishes the control processing.

In ST513, data relay packet processing section 114 performs reception processing of the data relay packet, and finishes the control processing.

In addition, details will be described later on the reception processing of the route error packet in ST509, the reception processing of the route search packet in ST510, the reception processing of the route response packet in ST511, the reception processing of the data transmission packet in ST512, and the reception processing of the data relay packet in ST513.

In ST514, control section 105 searches route cache 116 for an expired entry, and, when the expired entry exists (Yes), control section 105 deletes the entry from route cache 116 in ST515, and finishes the control processing. When the expired entry does not exist (No) the control processing is finished.

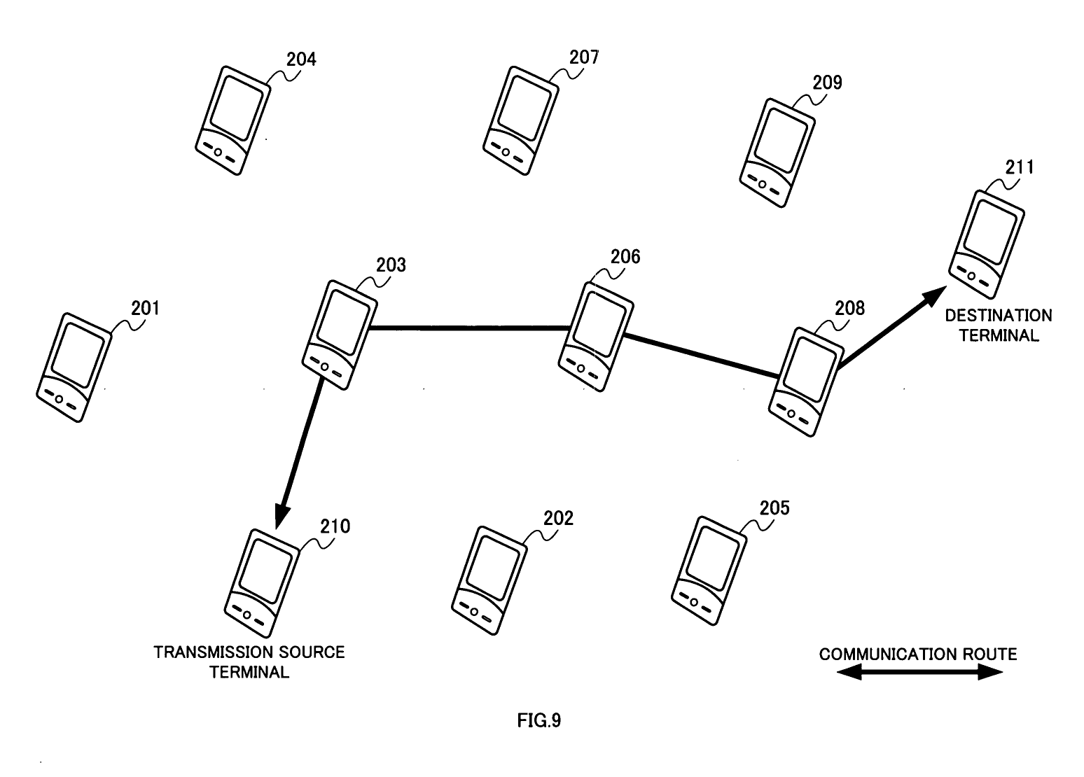

Herein, referring to FIG. 9 illustrating a network using the above-mentioned wireless adhoc terminal, a case will be considered where data packets are transmitted from transmission source terminal 210 to destination terminal 211 while being relayed by relay terminals 203, 206 and 208.

In this case, as information for each terminal to hold, transmission source terminal 210 holds identification information to identify a terminal (herein, identification information of relay terminal 203) on the destination terminal 211 side to directly transmit data, and each of relay terminals 203, 206 and 208 holds identification information on the destination terminal 211 side and transmission source terminal 210 side to directly transmit data. More specifically, relay terminal 203 holds identification information of relay terminal 206 and transmission source terminal 210, relay terminal 206 holds identification information of relay terminals 208 and 203, and relay terminal 208 holds identification information of destination terminal 211 and relay terminal 206. Destination terminal 211 holds identification information to identify a terminal (herein, identification information of relay terminal 208) on the transmission source terminal 210 side to directly transmit data.

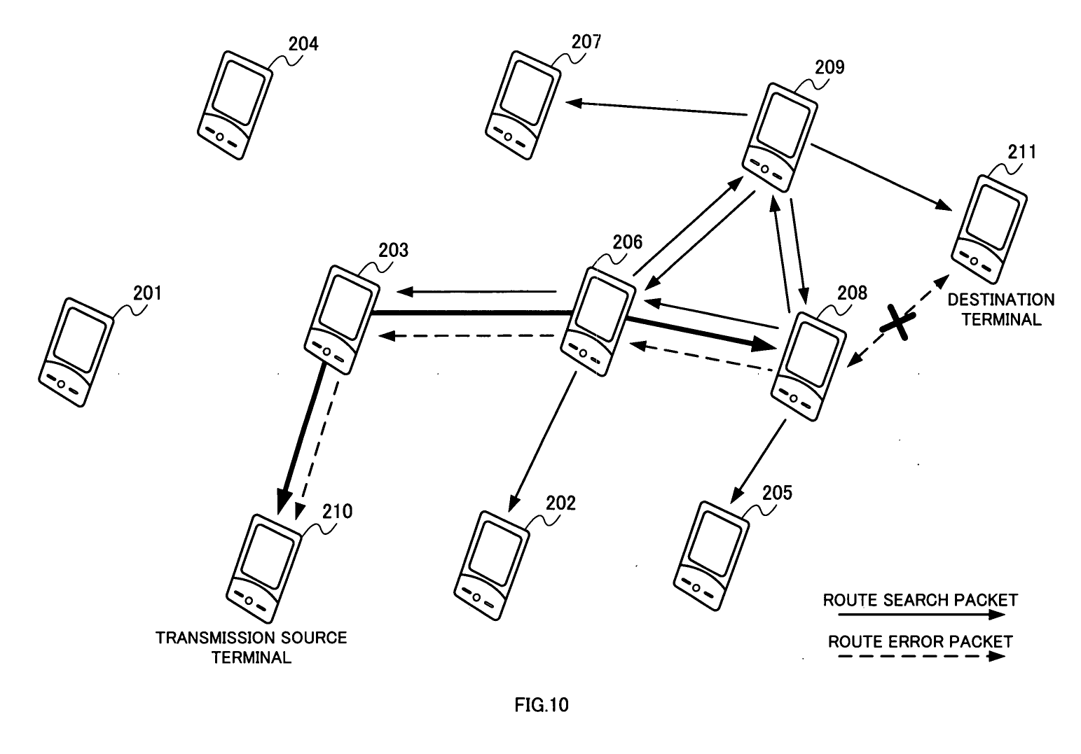

Then, during transmission of data packets, as shown in FIG. 10, due to moving of destination terminal 211 and the like, radio reception section 103 in relay terminal 208 detects a decrease in electric field strength of destination terminal 211, and reports control section 105 of disconnection of the route to destination terminal 211.

Control section 105 receiving the report of the disconnection of the route (ST501 in FIG. 8) searches route cache 116 of relay terminal 208 for a destination terminal that uses the reported relay terminal as a next relay terminal (ST502). When such a terminal exists, control section 105 deletes all the entries corresponding to the destination terminal (ST503).

Further, as shown in FIG. 10, relay terminal 208 transmits a route error packet to relay terminal 206, relay terminal 206 receiving the route error packet determines that the received packet is the route error packet in packet type determination (ST505), and route error packet processing section 111 performs the reception processing of the route error packet (ST509).

Meanwhile, as shown in FIG. 10, relay terminal 208 transmits a route search packet directed to destination terminal 211, and the route search packet is propagated to relay terminals 205, 206 and 209 that are adjacent terminals of relay terminal 208. Among the terminals, relay terminal 209 that is an adjacent terminal of destination terminal 211 determines that the received packet is the route search packet by packet type determination (ST506), and route search packet processing section 115 performs the reception processing of the route search packet (ST510).

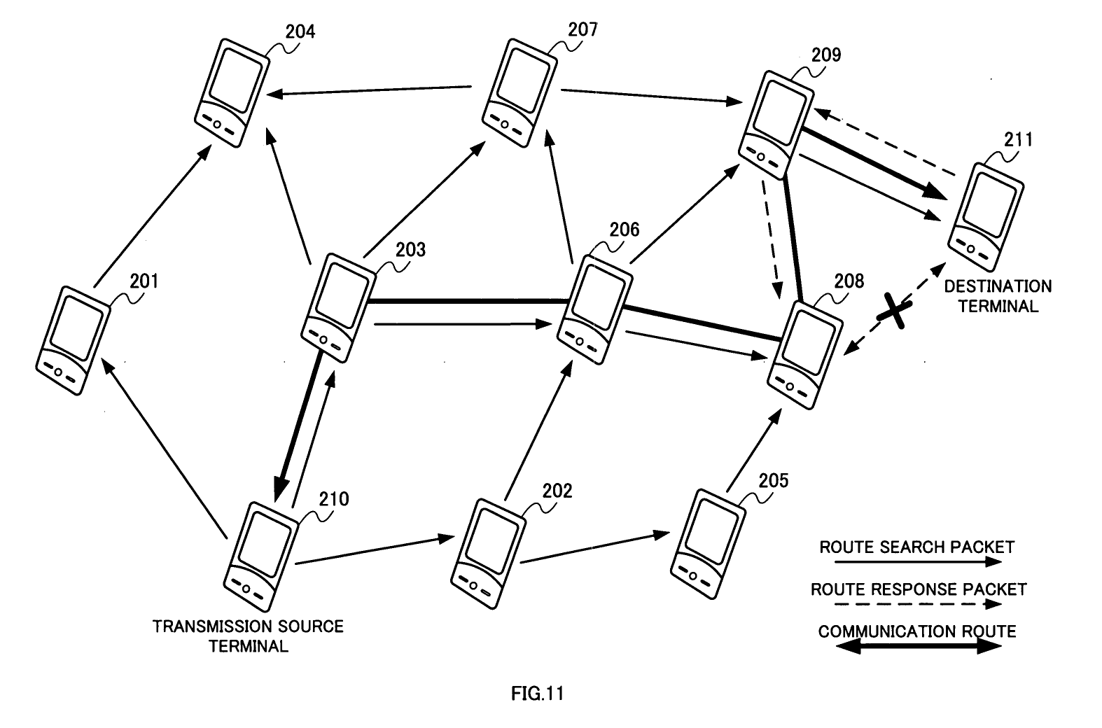

As shown in FIG. 11, destination terminal 211 receiving the route search packet transmitted from destination terminal 208 transmits a route response packet to relay terminal 209 that has directly transmitted the route search packet. Relay terminal 209 receiving the route response packet determines that the received packet is the route response packet (ST507) in packet type determination, and route response packet processing section 113 performs the reception processing of the route response packet (ST511).

Further, as shown in FIG. 11, during the process of propagation of the route search packet on the network by the route search packet processing, when an error type of a received route error packet is under-recovery, since a route from transmission source terminal 210 to relay terminal 208 recovering the route is not deleted, transmission source terminal 210 acquires a data transmission packet from routing upper section 117 (ST508), and data transmission packet processing section 112 performs the reception processing of the data transmission packet (ST512).

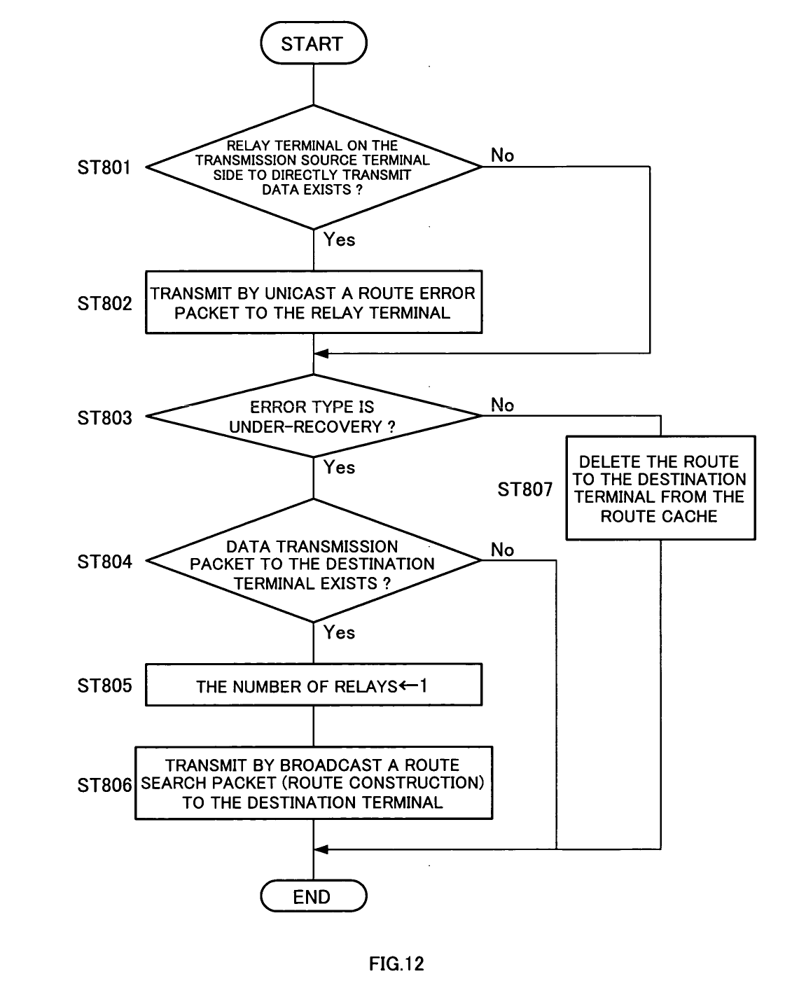

Next, specific procedures of the reception processing of the route error packet as shown in ST509 in FIG. 8 will be described with reference to FIG. 12. In FIG. 12, in ST801, when the route error packet is reported from relay terminal 208 to relay terminal 206, relay terminal 206 searches route cache 116 for a terminal (herein, relay terminal 203) on the transmission source terminal 210 side to directly transmit data. When such a terminal exists (Yes), the processing flow shifts to ST802, and, when such a terminal does not exist (No), the processing flow shifts to ST803.

In ST802, the terminal transmits by unicast the route error packet to another terminal searched in ST801, and thereby reports the error of the route. Herein, relay terminal 206 transmits the route error packet to relay terminal 203, and the route error type (under-route-recovery or route disconnection) contained in the route error packet is the same as the type contained in the route error packet transmitted from relay terminal 208.

In ST803, transmission source terminal 210 receiving the route error packet from relay terminal 203 determines an error type of the received route error packet, and, when the error type is under-route-recovery (Yes), the processing flow shifts to ST804, and, when the error type is route disconnection (No), the processing flow shifts to ST807.

In ST804, transmission source terminal 210 determines whether or not transmission source terminal 210 has a data transmission packet (data packet acquired from routing upper section 117 of transmission source terminal 210) to destination terminal 211, and, when the packet exists (Yes), the processing flow shifts to ST805, and, when such a packet does not exist (No), the reception processing of the route error packet is finished.

In ST805, transmission source terminal 210 sets the number of relays of the route search packet at “1”, and in ST806, transmits by broadcast the route search packet to destination terminal 211, as shown by the thin solid line in FIG. 11.

In ST807, since the type of the route error packet is determined as route disconnection in ST803, transmission source terminal 210 deletes the route to destination terminal 211 stored in route cache 116 in transmission source terminal 210, and finishes the reception processing of the route error packet.

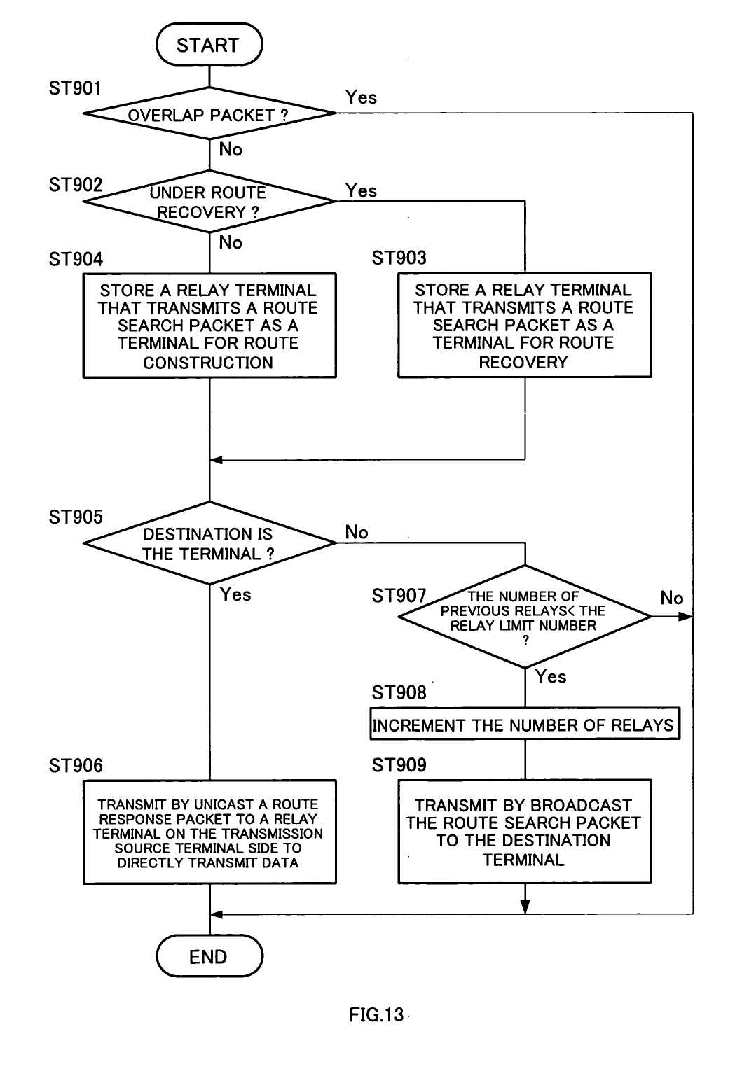

Next, specific procedures of the reception processing of the route search packet as shown in ST510 in FIG. 8 will be described with reference to FIG. 13. In FIG. 13, it is determined in ST901 whether or not the received route search packet is the same as an already received packet (overlap packet), and, when it is determined that the received packet is the overlap packet (Yes), the reception processing of the route search packet is finished, and, when it is determined that the received packet is not the overlap packet (No), the processing flow shifts to ST902.

Since the route search packet is propagated by broadcast, for example, when relay terminal 206 receives the route search packet transmitted from relay terminal 208 and further transfers the packet by broadcast, the route search packet also reaches relay terminal 209. However, relay terminal 209 has already received the same route search packet from relay terminal 208, and therefore, in ST901, processing of such an overlap packet is prevented.

In ST902, it is determined whether the received route search packet is for route recovery, and, when the received packet is determined to be the route search packet for route recovery (Yes), the processing flow shifts to ST903, and, when the received packet is determined not to be the route search packet for route recovery (No), the processing flow shifts to ST904.

In ST903, to construct a route to a terminal that is performing route recovery, the terminal stores the terminal that has transmitted the route search packet in a route recovery cache of the subject terminal as a terminal for route recovery (the apparent entry is the transmission source terminal, but is actually used for construction of the route to the terminal that is performing route recovery.)

In ST904, to construct a route to a transmission source terminal of the route search packet, the terminal stores the relay terminal on the transmission source terminal 210 side (relay terminal 208 actually transmits the route search packet, but the content of the packet is described as being transmitted from transmission source terminal 211) to directly transmit data as a terminal for route construction. For example, relay terminal 209 stores relay terminal 208 in route cache 116.

In ST905, a terminal determines whether a destination of the route search packet is the subject terminal, and, when the terminal determines that the destination is the subject terminal (Yes), the processing flow shifts to ST906, and, when the terminal determines that the destination is not the subject terminal (No), the processing flow shifts to ST907.

In ST906, as shown in FIG. 11, destination terminal 211 that determines in ST905 that the destination of the route search packet is destination terminal 211, transmits by unicast a route response packet to the terminal (that transmitted the route search packet to destination terminal 211) on the transmission source terminal 211 side to directly transmit data i.e. relay terminal 209.

In ST907, compared is the number of times the route search packet is already relayed with the number of permitted relays (relay limit number) which is determined for the route search packet to prevent the packet from being relayed without limit. When the number of times the packet is already relayed is less than the relay limit number (Yes), the processing flow shifts to ST908, and, when the number of times the packet is already relayed is not less than the relay limit number (No), the reception processing of the route search packet is finished without relaying, because the route search packet is not allowed to be propagated.

In ST908, the number of relays is incremented, the route search packet is transmitted by broadcast again to adjacent terminals in ST909, and the reception processing of the route search packet is finished.

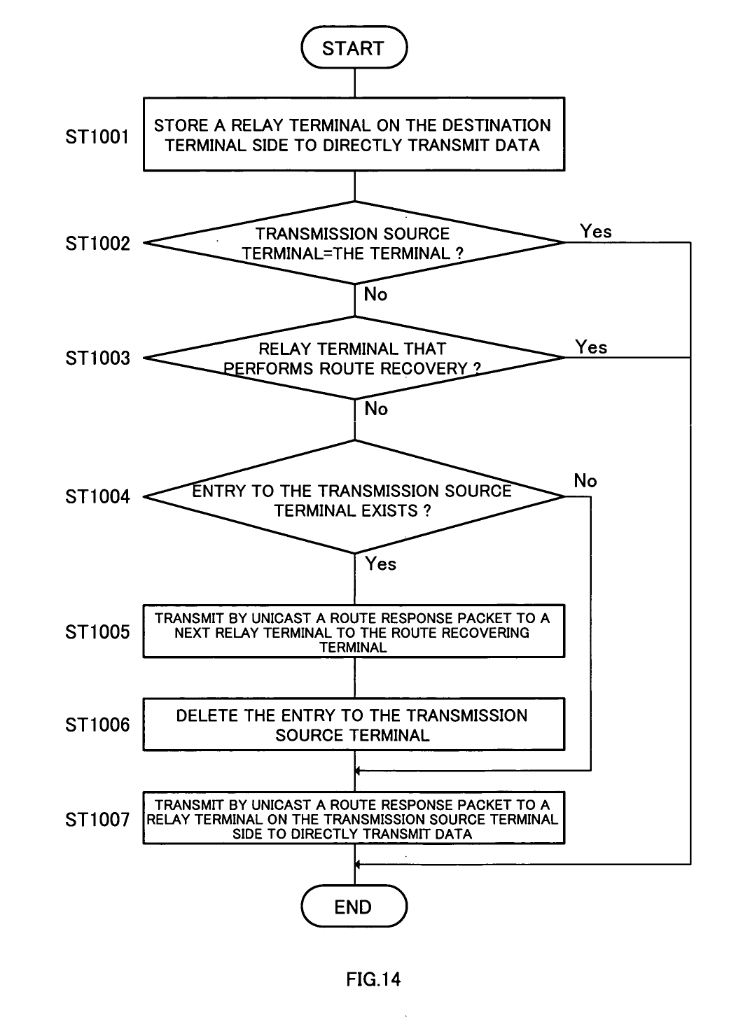

Next, specific procedures of the reception processing of the route response packet as shown in ST511 in FIG. 8 will be described with reference to FIG. 14. In FIG. 14, in ST1001, relay terminal 209 receiving the route response packet stores another terminal (that has transmitted the route response packet to relay terminal 209) on the destination terminal 211 side to directly transmit data i.e. destination terminal 211 in route cache 116 of relay terminal 209.

In ST1002, by determining whether or not a terminal as a destination of the route response packet i.e. the transmission source terminal (that is apparently transmission source terminal 211 although relay terminal 208 actually transmits the route search packet) of the route search packet is the subject terminal, the terminal determines whether or not to relay the route response packet. When the destination of the route response packet is the subject terminal, the terminal finishes a series of route establishing operation, and, when the destination of the route response packet is not the subject terminal (No), the processing flow shifts to ST1003.

In ST1003, the terminal determines whether or not relay terminal 209 has performed route recovery from the subject terminal to destination terminal 211, and, when the route recovery is already performed (Yes), the terminal finishes a series of route recovery operation, and, when the route recovery is not performed (No), the processing flow shifts to ST1004.

In ST1004, relay terminal 209 determined in ST1003 as not performing route recovery determines whether or not an entry to a transmission source terminal that is a destination of the received route response packet exists in route recovery cache 116, and, when such an entry exists (Yes), the processing flow shifts to ST1005, and, when such an entry does not exist (No), the processing flow shifts to ST1007.

In ST1005, destination terminal 211 transmits by unicast the route response packet to relay terminal 209 on the transmission source terminal (that actually recovers the route, herein relay terminal 208) side to directly transmit data, and in ST1006, deletes the entry to the transmission source terminal in route recovery cache 116. Next, in ST1007, the terminal transmits by unicast the route response packet to relay terminal 208 on the transmission source terminal 210 side to directly transmit data, and finishes the reception processing of the route response packet.

In addition, relay terminal 208 receives the route response packet from destination terminal 211 via relay terminal 209, determines in ST1003 that relay terminal 208 recovers the route to destination terminal 211, and finishes a series of route recovery operation. In this way, the route shown by the bold line in FIG. 11 is constructed by the route recovery operation of relay terminal 208.

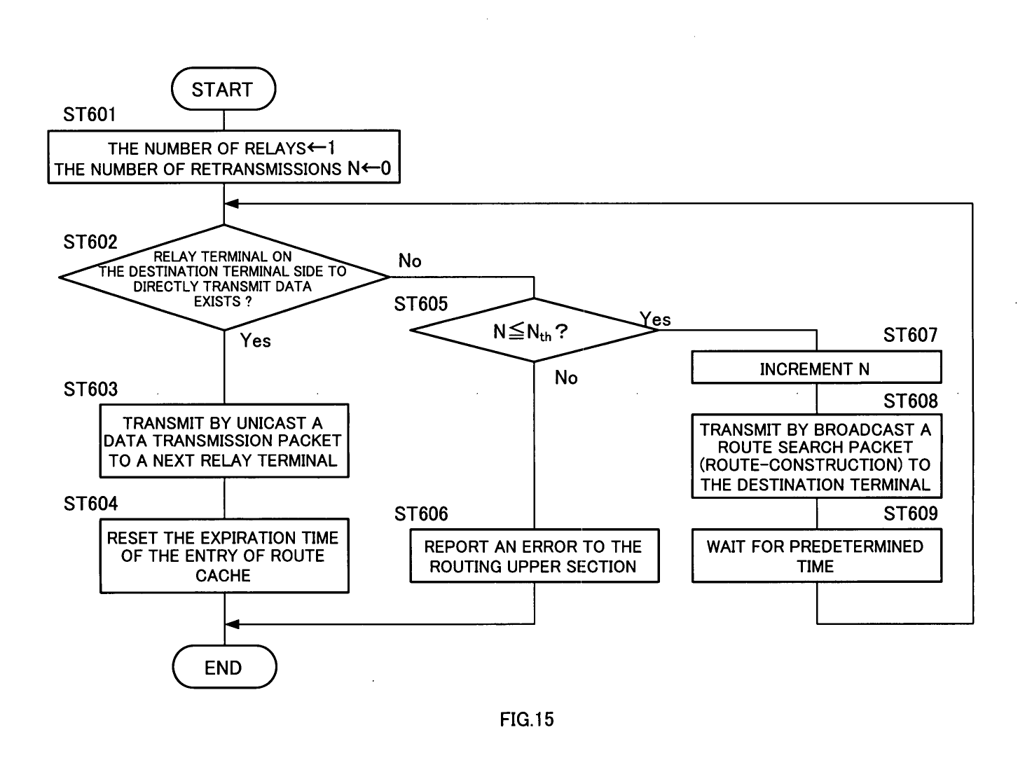

Next, specific procedures of the reception processing of the data transmission packet as shown in ST512 in FIG. 8 will be described with reference to FIG. 15. In FIG. 15, in ST601, the number of times a data packet is relayed is set at “1”, and the number of retransmissions is cleared to “0”.

In ST602, a terminal determines whether or not a relay terminal (herein, relay terminal 203) on the destination terminal 211 side to directly transmit data exists in route cache 116 of the subject terminal, and, when such a terminal exists in route cache 116 (Yes), the processing shifts to ST603, and, when such a terminal does not exist in route cache 116 (No), the processing shifts to ST605.

In ST603, the terminal transmits a data transmission packet by unicast to the relay terminal (relay terminal 203) determined in ST602 to exist in route cache 116. In ST604, the terminal resets the expiration time of the entry determined in ST602 to exist in route cache 116, and finishes the reception processing of the data transmission packet.

Meanwhile, when an error type of the route error packet received in transmission source terminal 210 is route disconnection, it is determined in ST602 that a relay terminal on the destination terminal 211 side to directly transmit data does not exist in route cache 116 of the terminal, and the route reconstruction operation in ST605 and subsequent steps are performed.

In ST605, it is determined whether the number N of retransmissions is less than the predetermined number (threshold Nₜₕ) of times, and, when N is less than the threshold Nₜₕ (Yes), the processing flow shifts to ST607, and, when N exceeds the threshold Nₜₕ (No), the processing flow shifts to ST606.

In ST606, since it is determined in ST805 that the number N of retransmissions exceeds the threshold Nₜₕ, the terminal reports to routing upper section 117 an error indicating that routing of the received data transmission packet cannot be performed, and finishes the reception processing of the data transmission packet.

In ST607, the number N of retransmissions is incremented, and in ST608, the route search packet to destination terminal 211 is transmitted by broadcast.

In ST609, predetermined time enough to complete the exchange of the route search packet and route response packet is waited, and the processing flow returns to ST602.

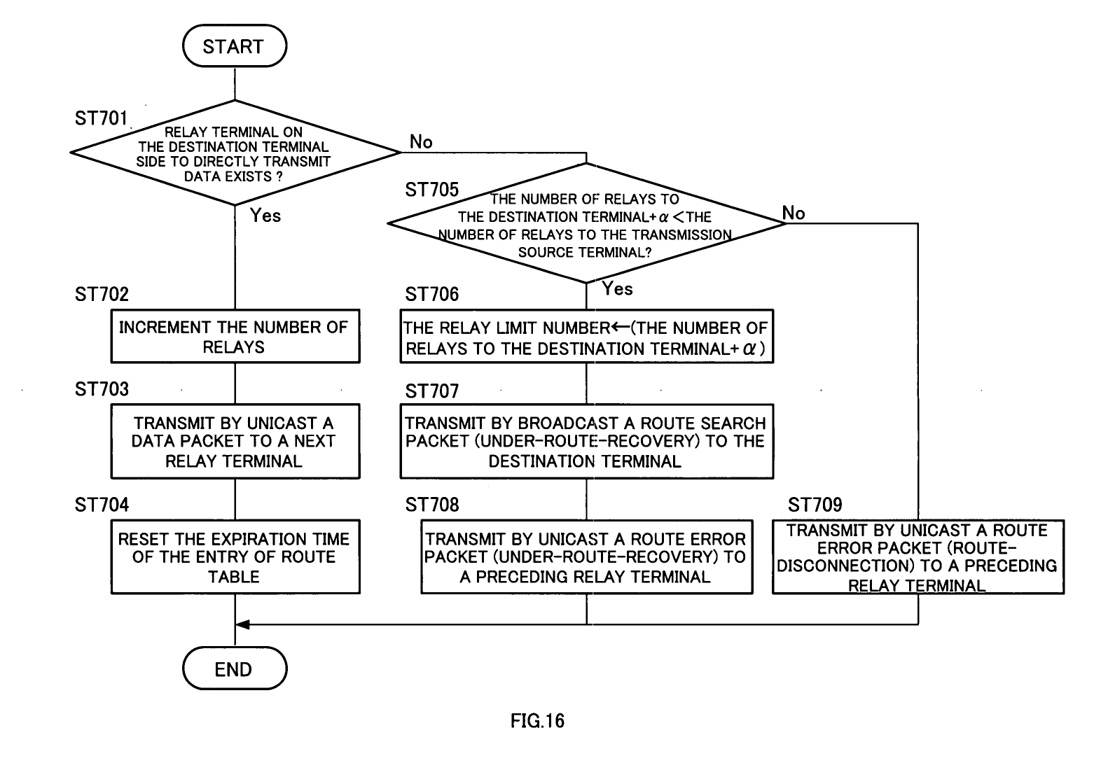

Next, specific procedures of the reception processing of the data relay packet as shown in ST513 in FIG. 8 will be described with reference to FIG. 16. In FIG. 16, in ST701, relay terminal 208 searches route recovery cache 116 for a relay terminal on the destination terminal 211 side to directly transmit data, and, when such a terminal exists in route cache 116 (Yes), the processing flow shifts to ST702, and, when such a terminal does not exist in route cache 116 (No), the processing flow shifts to ST705. In this case, since the route to destination terminal 211 is already deleted and does not exist, data packets to destination terminal 211 received from relay terminal 206 are stored in a transmission buffer.

Relay terminal 208 that finishes the route recovery recognizes in ST701 that relay terminal 209 is the relay terminal on the destination terminal 211 side to directly transmit data, and therefore, in ST702, relay terminal 208 increments the number of current relay times, and in ST703, transmits by unicast the data packets to destination terminal 211 stored in the buffer to relay terminal 209 that is a subsequent relay terminal.

In ST704, for example, using a data transfer confirmation response and the like in layer 2, when the terminal confirms that data transfer to relay terminal 209 is completed, the terminal resets the expiration time of the entry stored in route cache 116 of the terminal, and finishes the reception processing of the data relay packet.

In ST705, relay terminal 208 determined in ST701 that a relay terminal on the destination terminal 211 side to directly transmit data does not exist, compares a value obtained by adding a predetermined number (herein, a that can be set arbitrarily) to the number of relays from relay terminal 208 to destination terminal 211 before the route is disconnected with the number of relays to transmission source terminal 210. The processing flow shifts to ST706 when the value is less than the number (Yes), and, when the value is more than or equal to the number (No), the processing flow shifts to ST709.

In ST706, it is assumed that the route recovery to destination terminal 211 by relay terminal 208 is permitted, and the terminal sets as the relay limit number the value obtained by adding a predetermined number (herein, α that can be set arbitrarily) to the number of relays from relay terminal 208 to destination terminal 211 before the route is disconnected.

In ST707, relay terminal 208 transmits by broadcast the route search packet to destination terminal 211 with the content of the route search packet described as if the packet being the packet from transmission source terminal 210 to destination terminal 211 and clearly indicating that the packet is the route search packet for route recovery.

In ST708, to report that the route is being recovered to transmission source terminal 210, relay terminal 208 further transmits by unicast a route error packet indicating that the route to destination terminal 211 is under recovery to relay terminal 206 that is a relay terminal on the transmission source terminal 210 side to directly transmit data, and finishes the reception processing of the data relay packet.

In ST709, in the relay terminal determined in ST705 that the value is more than or equal to the number, because the route recovery to the destination terminal by the subject relay terminal is not permitted, the relay terminal transmits by unicast a route error packet reporting the route disconnection to a relay terminal on the transmission source terminal 210 side to directly transmit data, and finishes the reception processing of the data relay packet.

Here, the case of reconstructing the route will be described. First, transmission source terminal 210 receiving a route error packet transmits a route search packet from transmission source terminal 210 to destination terminal 211, and the route search packet is thereby subjected to the above-mentioned reception processing of the route search packet in each terminal, and propagated to destination terminal 211 that is a destination. Destination terminal 211 receiving the route search packet directed to destination terminal 211 transmits a route response packet to transmission source terminal 210.

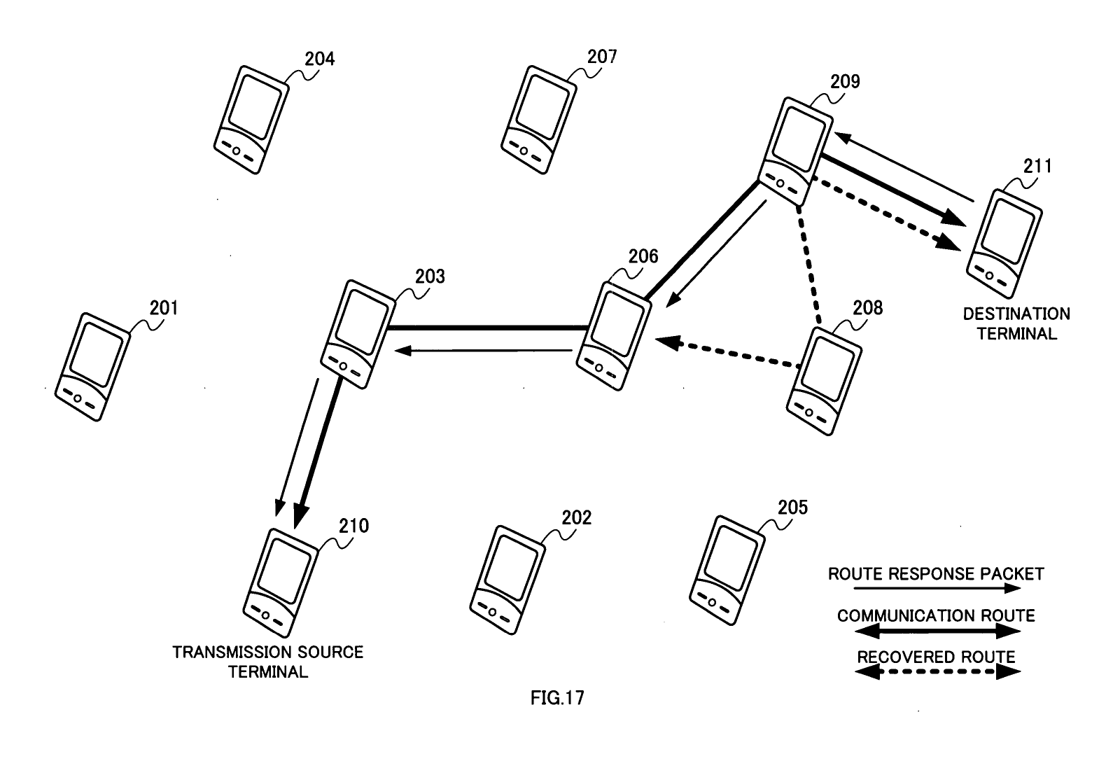

As shown in FIG. 17, relay terminal 206 receiving the route response packet switches a relay terminal on the destination terminal 211 side to directly transmit data from relay terminal 208 to relay terminal 209.

By this means, by the search for a route to destination terminal 211 by transmission source terminal 210, the communication route is formed of transmission source terminal 210→relay terminal 203→relay terminal 206→relay terminal 209→destination terminal 211 with total four relays, the above-mentioned recovered route is thus capable of decreasing the number of relays, which is five, of transmission source terminal 210 relay terminal 203→relay terminal 206→relay terminal 208→relay terminal 209→destination terminal 211, and subsequent communications are performed using the route with the lower number of relays.

Thus, by relay terminal 208 simultaneously performing route recovery to destination terminal 211 and route error report to transmission source terminal 210, it is possible to reduce the time taken between resumption of transfer of data packets to destination terminal 211 stored in relay terminal 208 and construction of an optimal route to destination terminal 211 by transmission source terminal 210.

While descriptions in the foregoing are on the assumption that a route (hereinafter, referred to as a “first communication route”) from transmission source terminal 210 to destination terminal 211 is recovered or constructed, an inverse route (hereinafter, referred to as a “second communicating route”) from destination terminal 211 to transmission source terminal 210 can be considered, and this case will be described below. In addition, it is assumed that in the first communication route, transmission source terminal 210 is upstream and destination terminal 211 is downstream, and that in the second communication route, transmission source terminal 210 is downstream and destination terminal. 211 is upstream.

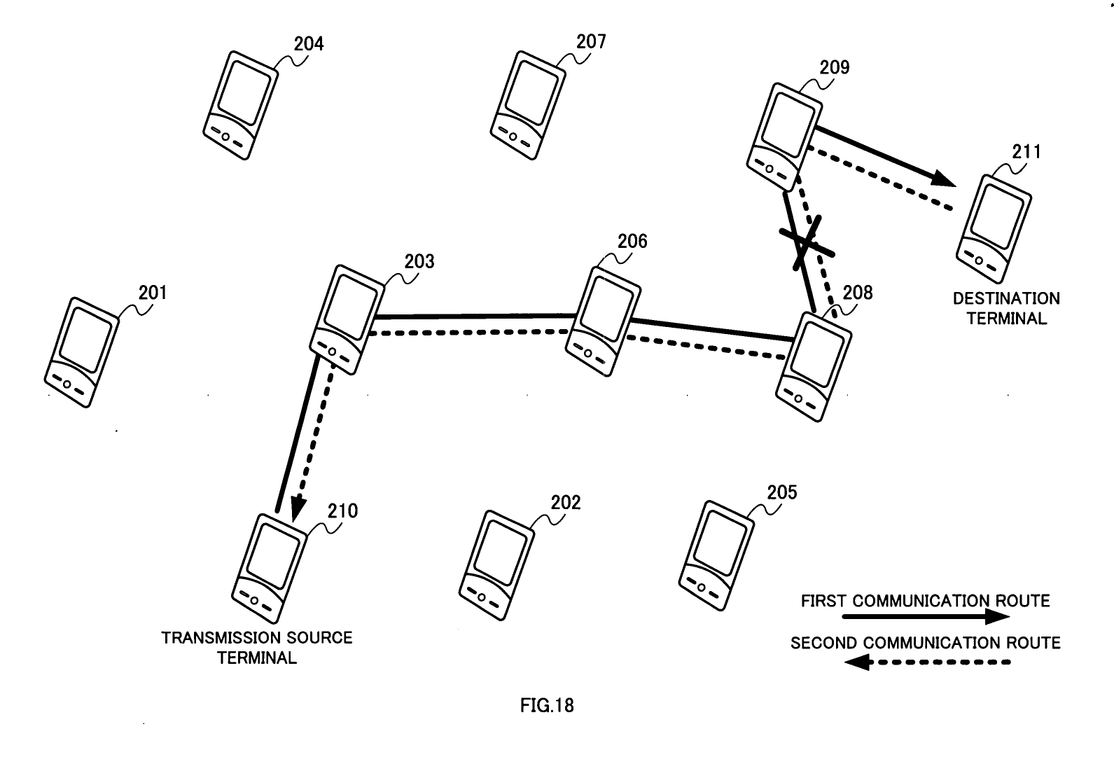

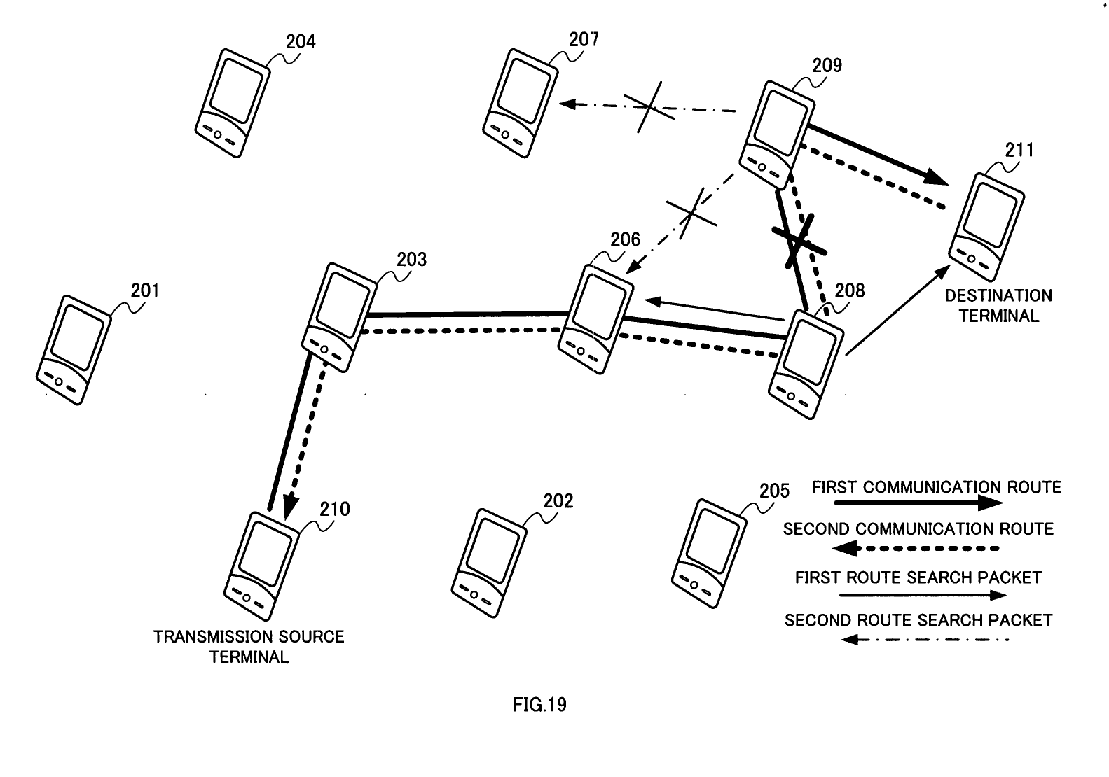

Herein, as shown in FIG. 18, a route is assumed to be established between transmission source terminal 210 and destination terminal 211 passing through relay terminals 203, 206, 208 and 209. A case is considered where route disconnection arises between relay terminals 208 and 209 during transmission of data packets using the route. When attention is focused on the second communication route, relay terminal 209 detects route disconnection, and compares each of the number of relays to transmission source terminal 210 and the number of relays to destination terminal 211 with a predetermined threshold. When the number of relays is less than the threshold, it is defined on the protocol that the relay terminal detecting the route disconnection transmits a route error report indicating the route disconnection to a terminal, without transmitting a route search packet to recover the route. Herein, relay terminal 209 recognizes that the number of relays to destination terminal 211 is less than the threshold, and, as shown in FIG. 19, transmits a route error report to destination terminal 211 without transmitting a second-route search packet.

Meanwhile, when attention is focused on the first communication route, relay terminal 208 detects route disconnection, and as already described, transmits by broadcast the route search packet to destination terminal 211 with the content of the packet described as if the packet is the route search packet from transmission source terminal 210 to destination terminal 211 and clearly indicating that the packet is the route search packet for route recovery.

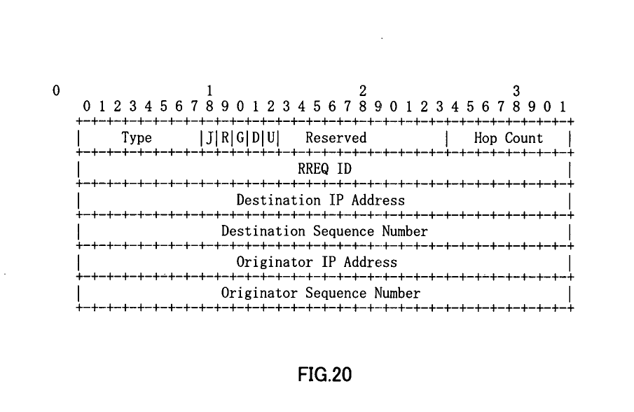

As shown in FIG. 20, each field is defined in the format of the route search packet. Among the fields, by adjusting “Hop Count” indicating the number of relays from the terminal detecting route disconnection to the transmission source terminal, “Originator IP Address” indicating an IP address of the transmission source terminal, and “Originator Sequence Number” indicating the latest sequence number of the transmission source terminal, it is possible to describe the content of the route search packet transmitted from relay terminal 208 as if the packet is transmitted from transmission source terminal 210.

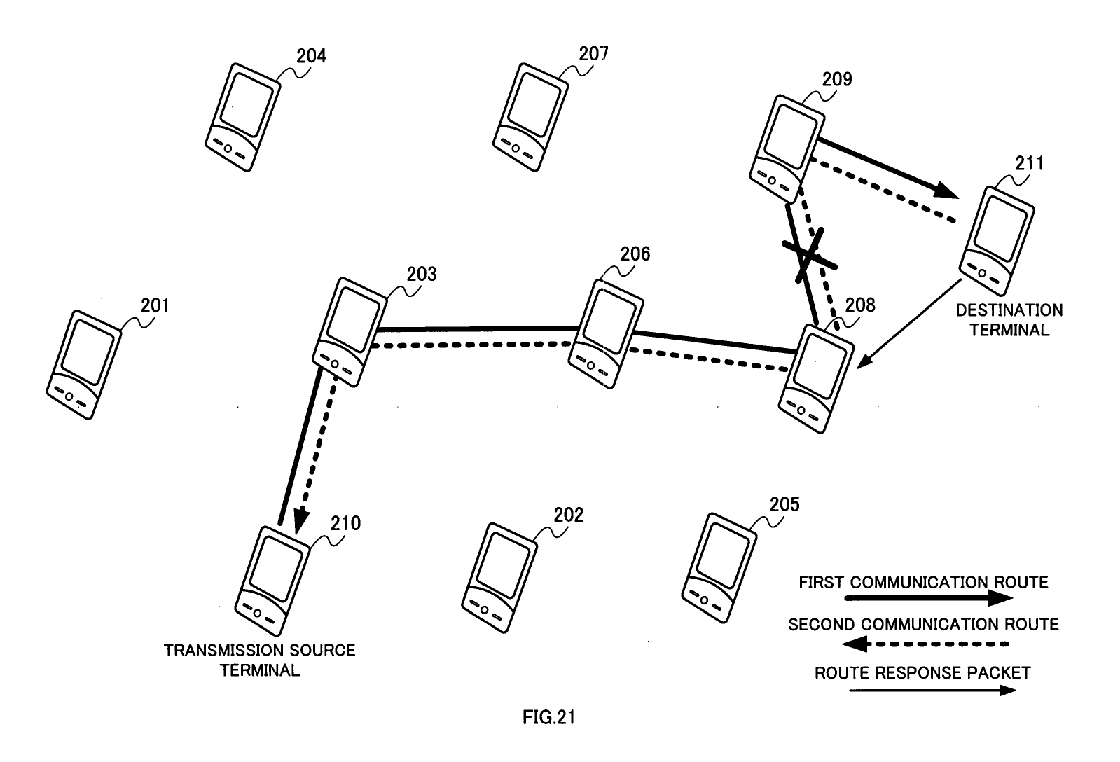

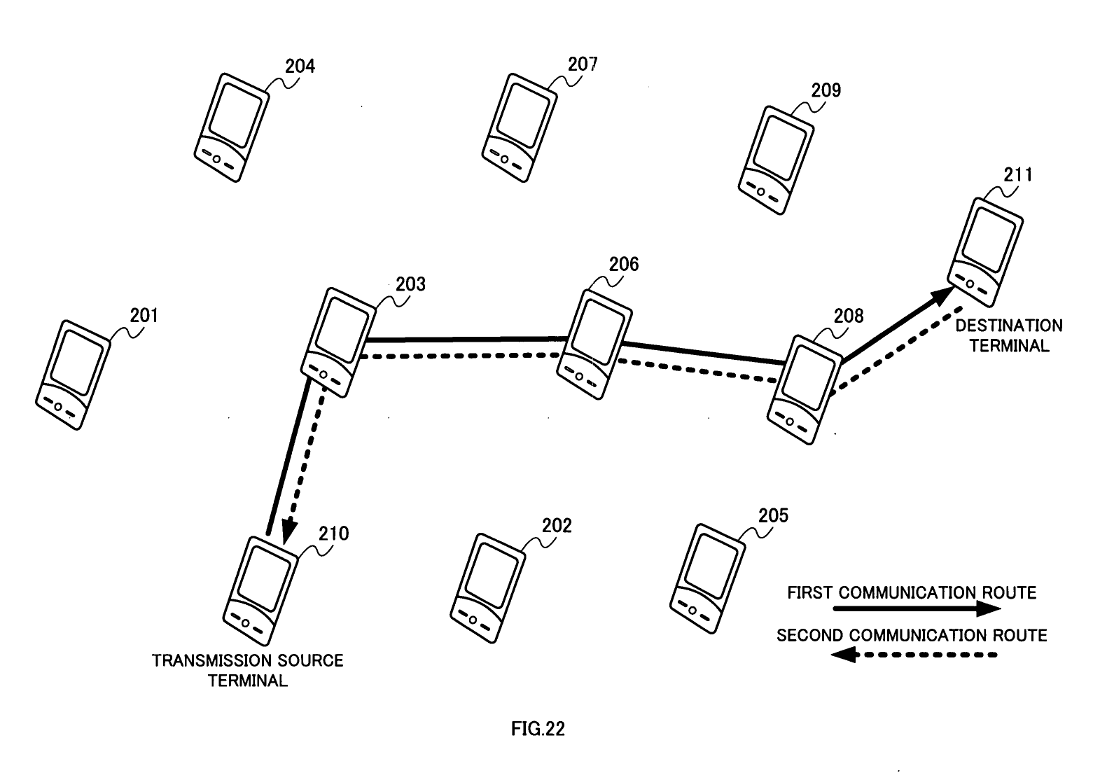

As shown in FIG. 21, for example, using a data transfer confirmation response and the like in layer 2, destination terminal 211 receiving the route search packet from relay terminal 208 updates the relay terminal on the transmission source terminal 210 side to directly transmit data from relay terminal 209 to relay terminal 208. In other words, destination terminal 211 is capable of recognizing that data packets can be transmitted to transmission source terminal 210 via relay terminal 208. It is thereby possible to promptly recover the second communication route as shown in FIG. 22.

Thus, according to this embodiment, a relay terminal that detects disconnection of the route transmits a route search packet to a destination terminal and reports the disconnection of the route to a transmission source terminal, and it is thereby possible to promptly recover the route to the destination terminal by the relay terminal and reduce the time elapsed before the transmission source terminal starts a search for an optimal route. Further, even when the relay terminal fails to recover the route to the destination terminal, it is possible to reduce the time elapsed before the transmission source terminal starts a search for a route to the destination terminal.

Further, by distinguishing between a route for route recovery and a route for route reconstruction and transmitting a route response on the destination terminal side from the route disconnection point, it is possible to construct a plurality of routes at the same time, even when different route requests from the same transmission source terminal.

In addition, the present invention is not limited to the above-mentioned embodiment, and is capable of being carried out with various modifications thereof. For example, the above-mentioned embodiment describes the case where the present invention is implemented as a packet routing apparatus, but the present invention is not limited to this, and the packet routing method is capable of being executed by software.

For example, a program to execute the above-mentioned packet routing method may be stored in advance in ROM (Read Only Memory) and executed by a CPU (Central Processor Unit).

Further, it may be possible to store a program to execute the above-mentioned packet routing method in a readable storage medium, further store the program stored in the storage medium in RAM (Random Access Memory) of a computer, and operate the computer according to the program.

A first aspect of the present invention is a packet routing apparatus having a receiver that receives a radio signal including packets, a detector that detects disconnection of a route for packet transfer, and a transmitter that, when the route for packet transfer is disconnected, transmits by broadcast a route search request to a destination of the packets and reports the disconnection of the route for packet transfer to a transmission source of the packets.

According to this configuration, a relay terminal that detects disconnection of the route transmits a route search packet to a destination terminal and reports the route disconnection to a transmission source terminal, and it is thereby possible to promptly recover the route to the destination terminal by the relay terminal and reduce the time elapsed before the transmission source terminal starts a search for an optimal route. Further, even when the relay terminal fails to recover the route to the destination terminal, it is possible to reduce the time elapsed before the transmission source terminal starts a search for a route to the destination terminal.

A second aspect of the present invention is a packet routing apparatus further having a controller that determines content of a received signal, and a route search packet processor that searches for a transfer route of packets, wherein the receiver receives a radio signal including a route search request to a destination of the packets relayed by an apparatus that relays the packets, or a request for route reconstruction transmitted from a transmission source of the packets due to disconnection of the route for packet transfer, the controller distinguishes between the route search request to the destination of the packets relayed by the apparatus that relays the packets and the request for route reconstruction transmitted from the transmission source of the packets due to disconnection of the route for packet transfer, and the route search packet processor searches for a transfer route of the packets when receiving the route search request to the destination of the packets relayed by the apparatus that relays the packets, and searches for a route of the packets to reconstruct when receiving the request for route reconstruction transmitted from the transmission source of the packets due to disconnection of the route for packet transfer.

According to this configuration, by distinguishing between a route for route recovery and a route for route reconstruction and transmitting a route response at a downstream terminal of the route disconnection point, it is possible to construct a plurality of routes at the same time, even when different route requests are received from the same transmission source terminal.

A third aspect of the present invention is a packet routing apparatus having a receiver that receives a radio signal including packets, a detector that detects disconnection of a route for packet transfer, and a transmitter that, when the route for packet transfer is disconnected, adjusts content of the search request so that the request looks like being made by the transmission source of the packets and transmits by broadcast a route search request to a destination of the packets.

According to this configuration, the packet reaches a wireless terminal apparatus as a transmission source via a wireless terminal apparatus that transmits the route search request from a wireless terminal apparatus as a destination based on the received route search request, whereby the route can be recovered promptly from the wireless terminal apparatus as the destination to the wireless terminal apparatus as the transmission source.

A fourth aspect of the present invention is a packet routing method in a system where packets are transmitted to a wireless terminal apparatus as a destination via a plurality of wireless terminal apparatuses, wherein wireless terminal apparatuses relaying the packets monitor route disconnection, a wireless terminal apparatus detecting route disconnection transmits a route search packet to the wireless terminal apparatus as the destination of the packets and reports the route disconnection to a wireless terminal apparatus as a transmission source, wireless terminal apparatuses relaying the packets reconstruct a route for packet transmission according to the route search packet, and the wireless terminal apparatus as the transmission source reconstructs the route when receiving information of the route disconnection.

According to this method, a relay terminal that detects disconnection of the route transmits a route search packet to a destination terminal and reports the disconnection of the route to a transmission source terminal, and it is thereby possible to promptly recover the route to the destination terminal by the relay terminal and reduce the time elapsed before the transmission source terminal starts a search for an optimal route. Further, even when the relay terminal fails to recover the route to the destination terminal, it is possible to reduce the time elapsed before the transmission source terminal starts a search for a route to the destination terminal.

A fifth aspect of the present invention is a packet routing method in a system where packets are transmitted to a wireless terminal apparatus as a destination via a plurality of wireless terminal apparatuses, wherein wireless terminal apparatuses relaying the packets monitor route disconnection, a wireless terminal apparatus detecting route disconnection adjusts content of a route search request to the destination of the packets so that the search request looks like being made by the transmission source of the packets and transmits a route search packet to the wireless terminal apparatus as the destination of the packets, the wireless terminal apparatus as the destination receiving the route search packet transmits a response to the wireless terminal apparatus detecting the route disconnection, and a route for packet transfer is thereby recovered.

According to this method, the wireless terminal apparatus as the destination recognizes that the packets can be transmitted to the wireless terminal apparatus as the transmission source via the wireless terminal apparatus that transmits the route search request based on the received route search request, whereby the route can be recovered promptly from the wireless terminal apparatus as the destination to the wireless terminal apparatus as the transmission source.

The present application is based on Japanese Patent Applications No. 2004-043562 filed on Feb. 19, 2004, and No. 2005-039447 filed on Feb. 16, 2005, entire contents of which are expressly incorporated by reference herein.

### INDUSTRIAL APPLICABILITY

The packet routing method and packet routing apparatus according to the present invention are suitable for use in a wireless communication apparatus and wireless LAN apparatus.

1. A packet routing apparatus comprising:
a receiver that receives a radio signal including packets;
a detector that detects disconnection of a route for packet transfer; and
a transmitter that, when the route for packet transfer is disconnected, transmits by broadcast a route search request to a destination of the packets and reports the disconnection of the route for packet transfer to a transmission source of the packets.

2. The packet routing apparatus according to claim 1, further comprising:
a controller that determines content of a received signal; and
a route search packet processor that searches for a transfer route of packets, wherein:
the receiver receives a radio signal including a route search request to a destination of the packets relayed by an apparatus that relays the packets, or a request for route reconstruction transmitted from a transmission source of the packets due to disconnection of the route for packet transfer;
the controller distinguishes between the route search request to the destination of the packets relayed by the apparatus that relays the packets and the request for route reconstruction transmitted from the transmission source of the packets due to disconnection of the route for packet transfer; and
the route search packet processor searches for a transfer route of packets when receiving the route search request to the destination of the packets relayed by the apparatus that relays the packets, and searches for a route of the packets to reconstruct when receiving the request for route reconstruction transmitted from the transmission source of the packets due to disconnection of the route for packet transfer.

3. A packet routing apparatus comprising:
a receiver that receives a radio signal including packets;
a detector that detects disconnection of a route for packet transfer; and
a transmitter that, when the route for packet transfer is disconnected, adjusts content of the search request so that the request looks like being made by the transmission source of the packets and transmits by broadcast a route search request to a destination of the packets.

4. A packet routing method in a system where packets are transmitted to a wireless terminal apparatus as a destination via a plurality of wireless terminal apparatuses, wherein wireless terminal apparatuses relaying the packets monitor route disconnection, a wireless terminal apparatus detecting route disconnection transmits a route search packet to the wireless terminal apparatus as the destination of the packets and reports the route disconnection to a wireless terminal apparatus as a transmission source, wireless terminal apparatuses relaying the packets reconstruct a route for packet transmission according to the route search packet, and the wireless terminal apparatus as the transmission source reconstructs the route when receiving information of the route disconnection.

5. A packet routing method in a system where packets are transmitted to a wireless terminal apparatus as a destination via a plurality of wireless terminal apparatuses, wherein wireless terminal apparatuses relaying the packets monitor route disconnection, a wireless terminal apparatus detecting route disconnection adjusts content of a route search request to the destination of the packets so that the search request looks like being made by the transmission source of the packets and transmits a route search packet to the wireless terminal apparatus as the destination of the packets, the wireless terminal apparatus as the destination receiving the route search packet transmits a response to the wireless terminal apparatus detecting the route disconnection, and a route for packet transfer is thereby recovered.
